(19) United States
(12) Patent Application Publication
(10) Pub. No.: US 2004/0139161 A1
(43) Pub. Date: Jul. 15, 2004

(54) Distribution of digital content

(76) Inventor: Jin Feei Loh, Petaling Jaya (MY)

Correspondence Address: Jin Feei Loh, 55 Jalan BU10/7, Bandar Utama, Petaling Jaya Selangor, 47800, MY

(21) Appl. No.: 10/476,452

(22) PCT Filed: Jul. 10, 2001
(86) PCT No.: PCT/SG01/00145

(30) Foreign Application Priority Data
May 9, 2001 (MY) P1 2001249

(51) Int. Cl. G06F 15/16

(52) U.S. Cl. 709/206; 717/168

(57) ABSTRACT

Advertisements are distributed by embedding them in a computer program and e-mailing the program to a user. When the program is run, it requests consent from the user to send a copy of itself to the user's contracts, such as those found in the user's local address book. On receiving consent, the program automatically mails itself to those contacts directly or via a remote server. The process is repeated at the contacts, allowing the advertisements to spread efficiently while maintaining the legitimacy that arises from each user's consent.

### FIELD OF THE INVENTION

This invention relates to the distribution of digital content via an electronic mail system, particularly but not exclusively to the delivery of advertising by e-mail over the Internet.

### BACKGROUND

A significant amount of advertising on the Internet is carried out by displaying banners on web pages which form part of the World Wide Web. However, even if a website is popular and enjoys a high hit rate, these banners are often ineffective, since users tend to ignore them. Much effort has therefore been focused on making advertising banners more appealing, for example by the use of streamed video and animated graphics rather than static graphic images.

Another form of online advertising includes unsolicited e-mails, commonly known as spam, that are mailed to arbitrarily selected e-mail accounts. This form of advertising is frowned upon by the Internet community and such e-mails are usually deleted by their recipients without being opened.

The present invention aims to provide a more effective method of delivering digital content such as advertising.

### SUMMARY OF THE INVENTION

According to the present invention, there is provided a method of distributing digital content via an electronic mail system, the content being associated with an executable program received by a first recipient, the method comprising requesting consent from the first recipient to make the program available to a second recipient, and in the event that consent is given, making the program available to the second recipient. The step of making the program available can comprise sending a copy of the program from the first recipient to the second recipient via the electronic mail system, or it can comprise sending a link to a location from which the program is available from the first recipient to the second recipient via the electronic mail system. The link can for example be a website address.

The method can alternatively include sending information identifying the program from the first recipient to a remote computer, from where it is made available to the second recipient. The step of making the program available can comprise sending a copy of the program from the remote computer to the second recipient via the electronic mail system, or it can comprise sending a link to a location from which the program is available from the remote computer to the second recipient via the electronic mail system.

By sending information identifying the program from the first recipient to the remote computer, rather than the program itself, the remote computer can send the latest version of the program to recipients. The latest version can have newer embedded advertisements, enhancements and/or bug fixes. Furthermore, the upload time or bandwidth utilisation for the first recipient to make the program available to other recipients is minimised.

Preferably, the step of requesting consent is performed by the program during its execution, for example by presenting the user with a dialog box with an option to send the program.

The functionality of the program can be amended in dependence on the outcome of the request for consent. For instance, the functionality of the program can be reduced in the event that consent is refused.

The second recipient can be identified from contact details stored by the first recipient, for example by the program scanning address books held by the first recipient. Since recipients of electronic mail are more likely to take notice of it if it is received from a person they know, software transmitted in this way has a better chance of survival than software received from an unknown organisation, so enhancing dissemination of the associated digital content.

The method of distributing digital content can further include measuring the distribution of the digital content. In the case of advertising propagating through the Internet, measuring the distribution permits quantification of the advertising readership, which in turns provides accounting data which can be useful for charging purposes. The measuring step can comprise notifying a third recipient when the program is executed, or notifying the third recipient that a message relating to the program has been sent to the second recipient or by recording access to a web page initiated from the program.

According to the invention, there is also provided a method of advertisement distribution via an electronic mail system, comprising delivering an executable program to a first recipient, the program including data relating to the advertisement, requesting consent from the first recipient to make the program available to a second recipient, and in the event that consent is given, making the program available to the second recipient by electronic mail.

Preferably, the data relating to the advertisement comprises the advertisement.

According to the invention, there is further provided a computer program associated with digital content to be distributed via an electronic mail system, comprising means for requesting consent from a current user of the program to make the program available to at least one further user via an electronic mail system, and in the event consent is given, making the program available to said at least one further user.

The invention also provides a system for distributing digital content via an electronic mail system, the content being associated with an executable program received by a first recipient at a client computer, the program being configured to request consent from the first recipient to make the program available to a second recipient and in the event that consent is received, to send contact information for the second recipient and information identifying the program to a remote server, the remote server being configured to make the program available to the second recipient.

### BRIEF DESCRIPTION OF THE DRAWINGS

Embodiments of the invention will now be described by way of example with reference to the accompanying drawings, in which:

FIG. 1 is a schematic diagram of a first Internet based architecture for implementing the invention, showing personal computers connecting to the Internet;

FIG. 2 is a more detailed diagram showing the components of a personal computer shown in FIG. 1;

FIG. 3 is a flow diagram illustrating a first advertisement delivery aspect of the invention;

FIG. 4 is a schematic diagram illustrating a second Internet based architecture for implementing the invention;

FIG. 5 is a flow diagram illustrating a second advertisement delivery aspect of the invention;

FIG. 6 is a flow diagram illustrating a method of providing an incentive for a first recipient of an advertisement to provide valid contact addresses for other, potential recipients;

FIG. 7 is a flow diagram illustrating the advertisement accounting aspect of the invention;

FIG. 8 is a schematic diagram illustrating the processes involved in a usage accounting method of advertisement accounting;

FIG. 9 is a schematic diagram illustrating the processes involved in a copy accounting method of advertisement accounting; and

FIG. 10 is a schematic diagram illustrating the processes involved in a web hits accounting method of advertisement accounting.

### DETAILED DESCRIPTION

In the following description, only those features of conventional computers relevant to an understanding of the present invention, will be described in detail. However, it will be understood that the computers referred to have the necessary operating and application software and the necessary hardware to perform their required functions.

For example, a computer capable of accessing the Internet will have a modem and the necessary dial-up software to enable it to connect to the Internet via an Internet Service Provider, or, where the computer connects to a LAN which is in turn connected to the Internet, the computer will have the necessary hardware such as a network interface card.

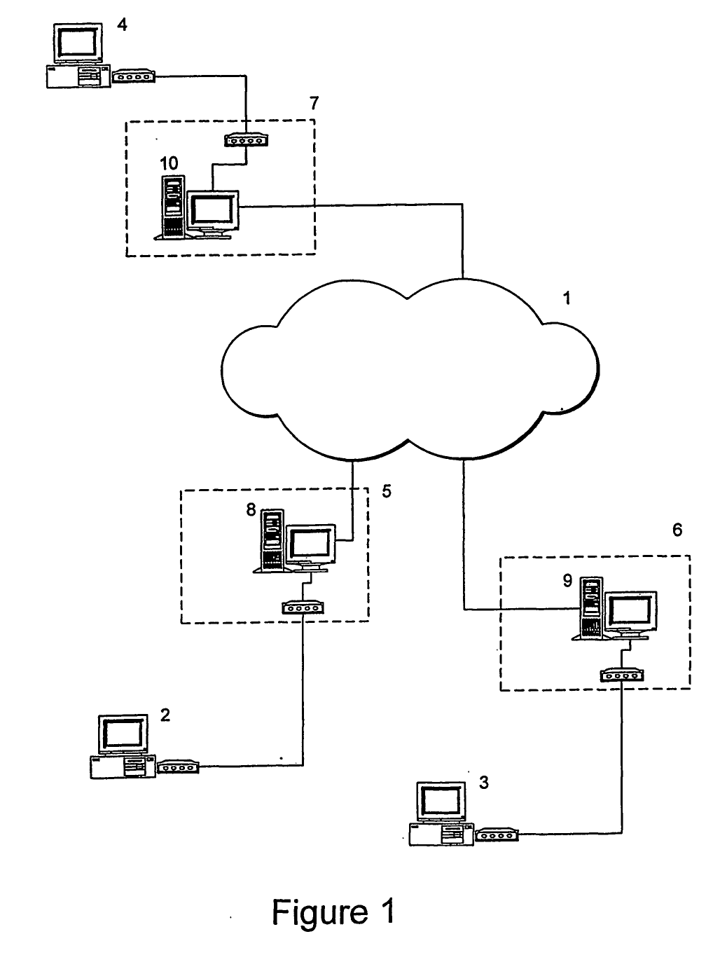

Referring to FIG. 1, users access the Internet 1 through respective conventional computers 2, 3, 4, for example Pentium based machines running Microsoft Windows 98™, which connect to the Internet 1 using, for example, dial-up connections via respective Internet service providers (ISPs) 5, 6, 7. Each ISP provides an e-mail server machine 8, 9, 10 running the well-known SMTP and POP3 servers which allow e-mails to be sent and received between the various computers 2, 3, 4. An e-mail client program, for example Outlook Express™ or Eudora™, running on each computer 2, 3, 4, enables it to send and receive e-mail by connecting to the e-mail server machine 8, 9, 10 at its ISP. While three personal computers are shown in FIG. 1, this is representative of any number of computers capable of accessing the Internet.

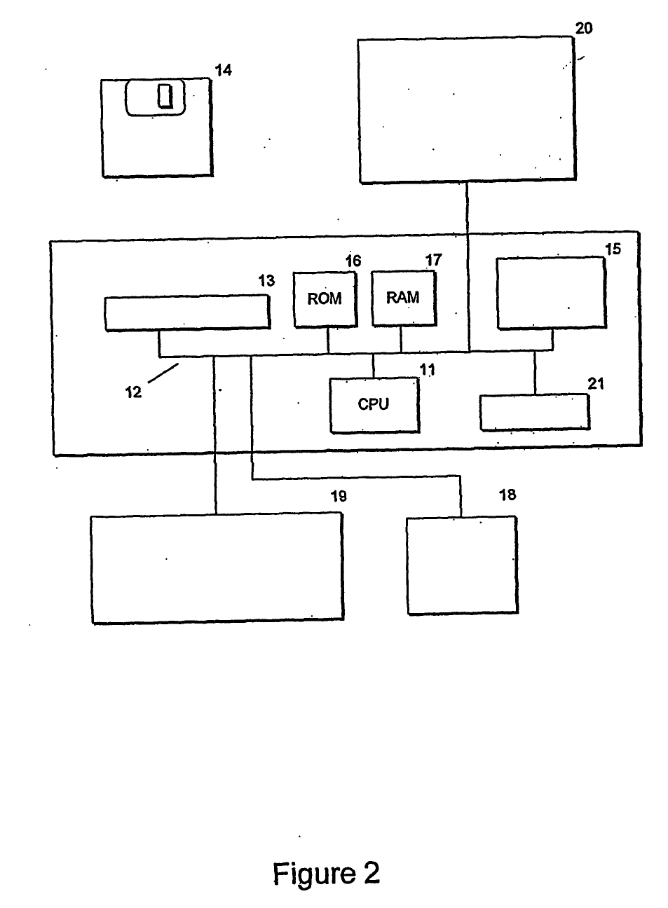

Referring to FIG. 2, a personal computer 2, 3, 4 comprises a central processing unit (CPU) 11 for executing computer programs and managing and controlling the operation of the computer. The CPU 11 is connected to a number of devices via a bus 12, the devices including a read/write device 13, for example a floppy disk drive, for reading and writing data and computer programs to and from a removable storage medium such as a floppy disk 14, a storage device 15, for example a hard disk drive, and memory including ROM 16 and RAM 17. The computer further includes user input/output devices such as a mouse 18, keyboard 19 and display 20. The computer is also provided with a modem 21. It will be understood that the features described above are not essential to the invention but merely describe a typical example of a conventional computer. Other variations are possible, for example, the computer may be provided with a CD ROM or DVD drive.

The operation of the invention will now be described in detail below.

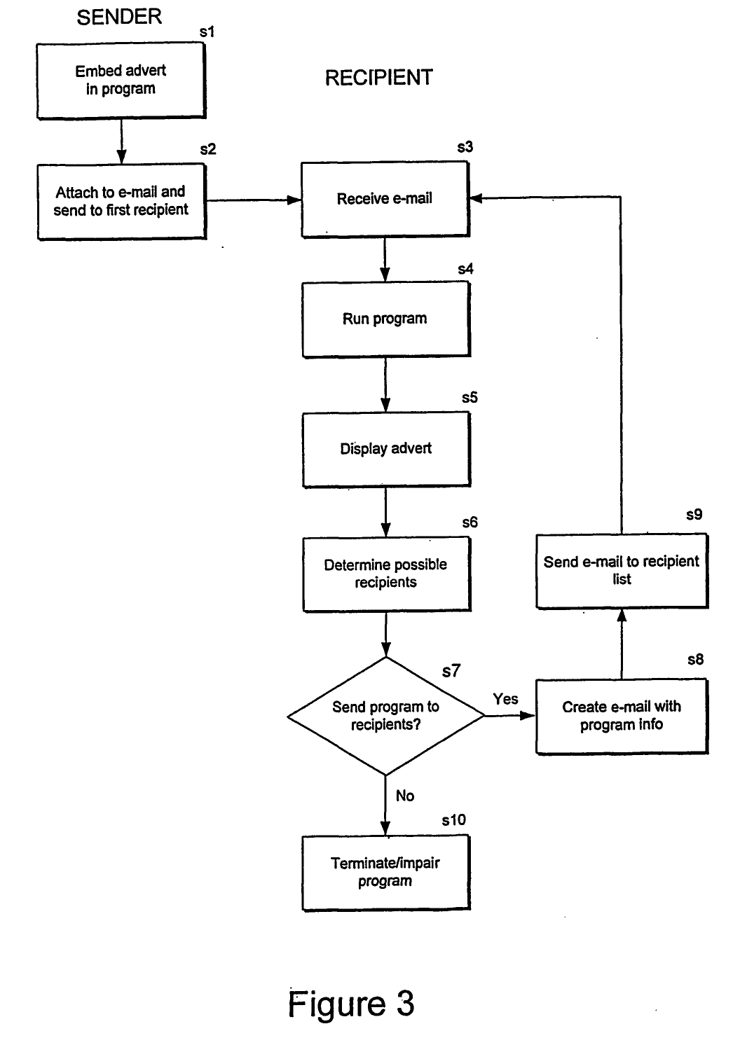

Referring to FIG. 3, desired advertisements are incorporated in a computer program (step s1). The program can be, for example, a game, a utility such as encryption or compression software or common application software such as word processor and spreadsheet software. The incorporation of advertisements into a computer program can be done in numerous ways, depending on the results to be achieved. At its simplest, the program includes program code which displays a stored graphic image during execution. Further examples of the way in which advertisements can be incorporated or embedded in a computer program are discussed below. As an alternative to incorporating advertisements directly, a reference to a location at which the advertising images can be found is embedded in the program. For example, the reference is a link to a web page.

The advertisement software comprising a program with its embedded advertisement or reference, is then included as an attachment in an e-mail message, for example as an executable EXE file, and sent to the first recipient (step s2). The majority of e-mail clients are MIME (Multipurpose Internet Mail Extensions) compliant and so permit the transmission of non-text attachments such as graphics files and programs by electronic mail in MIME format. The recipient receives the e-mail (step s3) by connecting to his ISP and downloading the mail in his mailbox. He then runs the attachment (step s4), for example by double-clicking on it. The program runs and displays the embedded advertisement (step s5). As mentioned above, the way in which this is displayed depends on the method by which the advertisement has been incorporated in the program. For example, on start up, the program can display a splashscreen with the desired advertisement. Alternatively, the program can display the advertisement as a background image or text in one of the software windows, or a pop-up window containing the advertisement can be displayed periodically.

Where a link to a web page has been coded into the program, the program launches an auxiliary program, for example an Internet browser such as Netscape Navigator™, to display the desired advertisement, for example a web page which is downloaded from a remote computer over the Internet.

The advertisement can also be downloaded automatically from a specific remote computer by the program at predetermined intervals, to ensure that it is constantly updated. Software having an outdated advertisement can disable itself and can at the same time display a message explaining how and where an updated version can be obtained.

In a further example, rather than automatically connecting to a remote web server over the Internet, the program displays a link to a web page and runs with a reduced functionality until the user visits the web page by clicking on the link. To ensure that a user spends at least some time looking at an advert on a web page, the software runs with reduced functionality until a password, which can be found at the website, has been entered.

A number of different advertisements can be embedded in a single program. These can be displayed sequentially to users or together, for example in the form of multiple windows or window panes. Different advertisements can also be displayed depending on the computer or user profile. For example, based on the time zone or country information that is stored in the computer system being used by the user, the program can determine the appropriate advertisement to cater for that particular market segment.

During the running of the program, the program seeks out further possible recipients (step s6). This is done in a number of ways. For example, the program scans the user's address books held on the local or networked computer and presents him with a dialog box or graphical user interface for him to select the desired recipients from the list of addresses retrieved. In another example, the program scans the local computer and any remote computers it has access to, including for example the inbox, outbox and sent mailbox of the user's e-mail system, for valid e-mail addresses. A dialog box is again presented to the user for him to select recipients from the resulting list of addresses. Finally, in another example, the program displays a dialog box and requests the user to enter the e-mail addresses of recipients of his choice. When the selection is complete, the software requests consent to send itself to the selected recipients (step s7), for example by showing a dialog box with ‘Send’ and ‘Don't Send’ options.

If the user grants consent to the advertisement software being sent to one or more further recipients, then the program creates a copy of itself together with an e-mail to the next recipients. In an alternative example, the program simply inserts a link to a website containing a copy of itself into the e-mail to the next recipients (step s8).

The program then sends the e-mail to the next recipient (step s9) and the process is repeated at the next recipient. If on receipt of an e-mail, the body of the e-mail only includes a link to the program, the recipient double clicks on the link, which automatically activates a Web browser installed on the recipient's computer, for example, Netscape Navigator™, to enable the program to be downloaded. Once downloaded the program is run as before (step s4).

In the event that the user does not grant consent to send the advertisement software to the required minimum number of recipients, the program can be terminated or its functionality reduced (step s10). For example, it may be a condition of the program that the program is sent to at least two further recipients.

It is envisaged that the user can be encouraged to send the program to as many recipients as possible by providing him with progressively increasing access to the functionality of the program. For example, limited functionality is provided if the user agrees to transfer the program to one other recipient, normal functionality is provided if the user consents to transmission to two recipients and enhanced functionality is provided if the user consents to transmission to three or more recipients. In the case of game software, progressive functionality is implemented by allowing the user access to additional levels of the game for each additional recipient.

The program can be arranged to ask the user for consent to send itself out periodically, for example after every five uses. The sanctions for refusal to consent are as set out above.

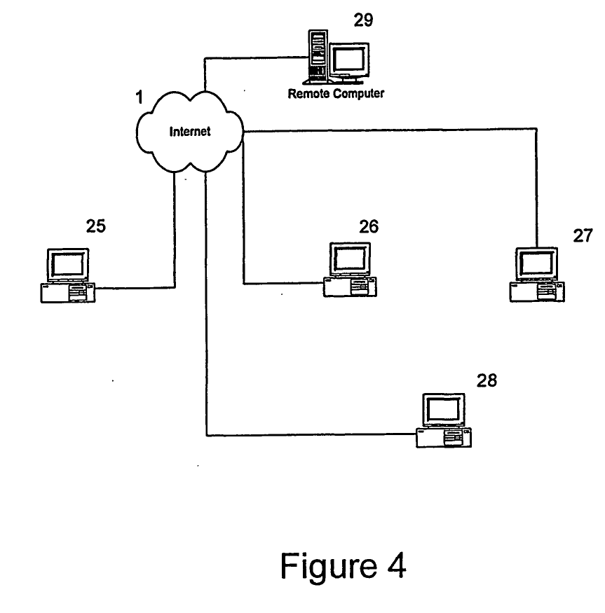

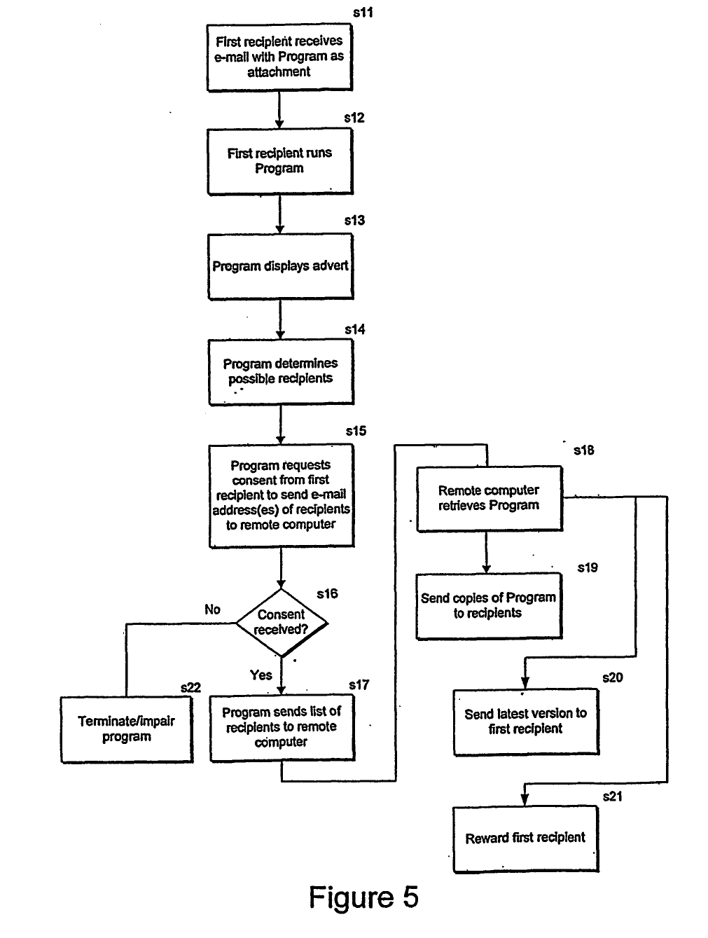

In a further embodiment of the invention illustrated in FIGS. 4 and 5, a first recipient 25 receives the e-mail with its attachment comprising a program with embedded advertising (step s11) and runs the attachment (step s12). The program displays the embedded advertisement on execution (step s13). At predetermined times, the program determines further possible recipients 26, 27, 28, for example, by scanning the address book of the first recipient 25 or by other methods as described, for example, in relation to the first embodiment above (step s14). The program then requests consent from the first recipient 25 to make copies of the program available to the determined recipients 26, 27, 28 (step s15). If consent is received (step s16), the program sends the contact information for the proposed recipients, for example their e-mail addresses, to a predetermined remote computer 29, via the Internet 1, together with information identifying the first recipient 25 and the program (step s17). The information identifying the program can include its current software version. Supplementary information can also be included, such as details of how many times the program was run and information gathered from the first recipient's computer, for example, geographical location and time zone. The information transmission in step s17 can be by e-mail, or by any form of internet connection, for example TCP/IP sockets.

The remote computer 29 has access to a copy of the program, which may reside in its local memory or at another remote computer site accessible via the network 1. The remote computer 29 retrieves the program, for example, its latest version (step s18) and sends it, via the electronic mail system, to the predetermined recipients 26, 27, 28, identifying the first recipient as the sender (step s19). The program can be sent as an attachment or as a link to a location from where it can be retrieved. The remote computer 29 can be configured to automatically send out a different version of the program depending on the format of the e-mail addresses of the recipients. For example, it can send out a Chinese version of the program when the recipient's e-mail address has a Chinese domain name ending such as .cn.

If the information identifying the program sent by the program from the first recipient 25 to the remote computer 29 (step s17) indicates that the program is not the latest version of the program, the latest version can also be sent to the first recipient 25 by e-mail (step s20). Furthermore, to reward the first recipient for sending the e-mail addresses, the remote computer 29 can send the first recipient 25 an enhanced version of the program with more functionality, a password to unlock further functionality in the program or an electronic token to enable certain functionality of the program to be run a predetermined number of times (step s21).

The remote computer 29 can maintain a database of recipients to prevent multiple copies of the same program being sent to the same recipient. This information can be used for accounting purposes, particularly since all advertising propagation traffic passes through the remote computer. The remote computer 29 can also send out other programs or data in its store to recipients, for example with the consent of the first recipient.

In the method described above, the remote computer 29 acts as a proxy for the propagation of the program. The e-mails to further recipients identify the first recipient as the sender and so ensure the legitimacy of the transmission process. However, in the event that the first recipient wishes to remain anonymous, he can indicate this to the program, for example through an options screen. In this case, when this information is communicated to the remote computer 29, it sends e-mails to recipients using its own identity instead.

In the event that consent to forward the program to other recipients is not received from the first recipient, the program is terminated or its functionality reduced (step s22) as in the case of the first embodiment described above.

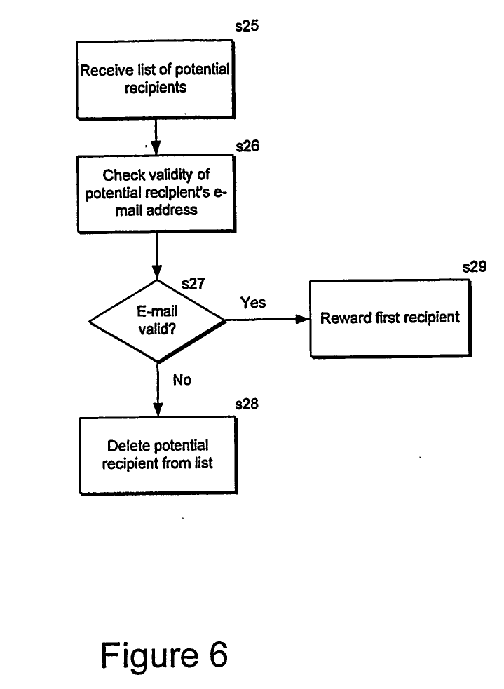

FIG. 6 illustrates a method of encouraging the first recipient 25 to provide valid e-mail addresses for onward transmission of the program. When the remote computer 29 receives the list of possible further recipients from the first recipient (step s25), it checks the validity of the e-mail addresses of each of the potential further recipients by sending an e-mail to the e-mail address (step s26). If the e-mail bounces because the e-mail address is invalid (step s27), then the potential recipient is deleted from the list (step s28). If the e-mail address is valid, the first recipient is rewarded in a similar manner to that already described in relation to FIG. 5 (step s29). Other methods of verifying the validity of the e-mail addresses can also be used, such as the TCP/IP ‘finger’ service or the VRFY command of the Simple Mail Transfer Protocol (SMTP), which lets the remote computer 29 verify the validity of a recipient e-mail address without sending e-mail to the recipient.

The success or failure of the above described methods of online advertising essentially depends on how effectively the program together with its embedded adverts is disseminated through the e-mail system. A number of methods can be used to measure the dissemination efficiency and so provide accounting data which can be used for charging purposes. The various methods can be divided into the categories of usage accounting, copy accounting and web-hits accounting.

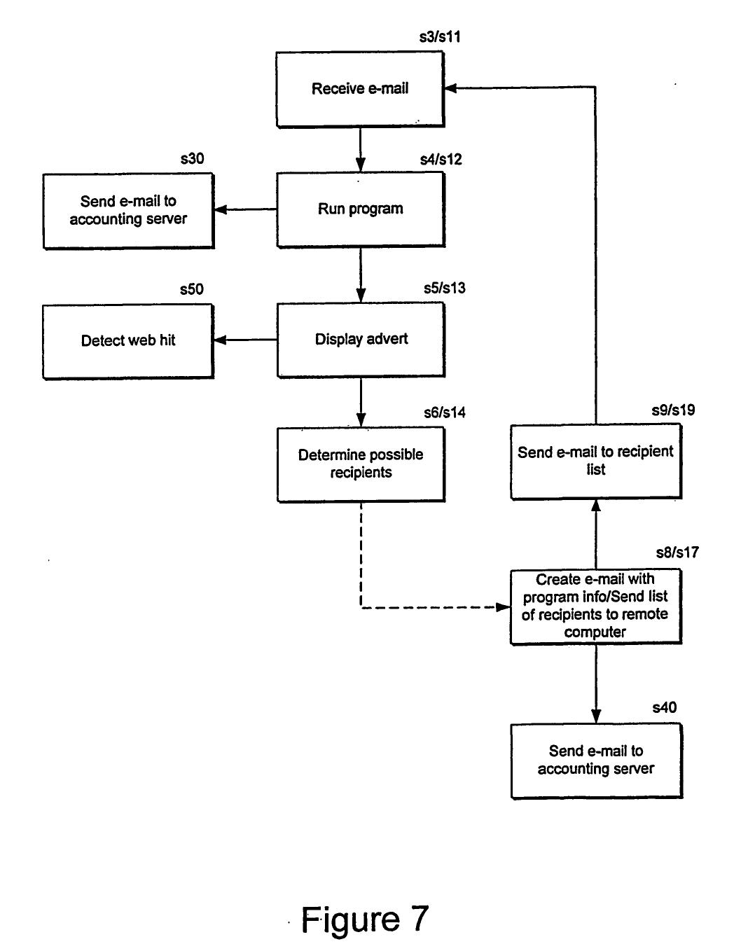

FIG. 7 illustrates how the various accounting methods, which are described in detail below, integrate with the advertisement dissemination methods shown in FIGS. 3 and 5.

Usage Accounting

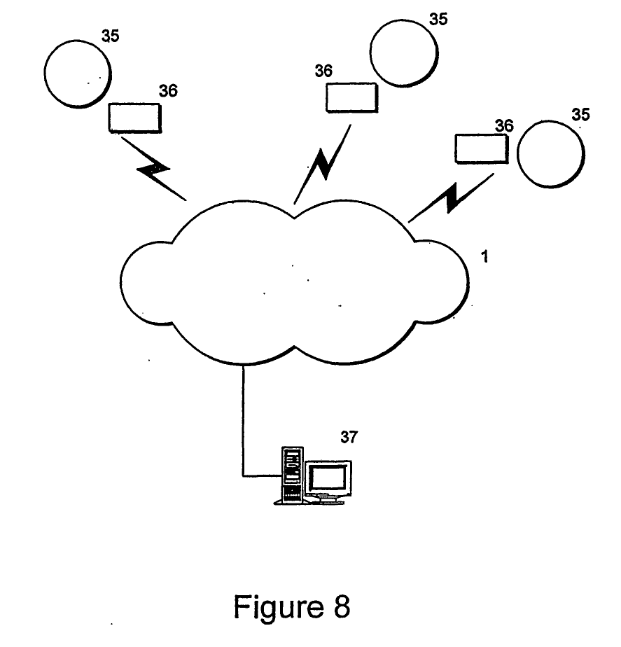

FIG. 8 shows the program running at a plurality of user locations 35. Referring to FIGS. 7 and 8, each time the program is run (step s4/s12), an e-mail 36 is automatically generated which is sent via the Internet 1 to an accounting mail server 37 (step s30). The recipient of the e-mails at the mail server 37 can gather total usage statistics based on all of the e-mail messages received at the mail server 37. The e-mail 36 is generated and sent once only when the software is first used or can be sent at certain predetermined periods of times, for example when an Internet connection is available, or after the program has been used a predetermined number of times.

Copy Accounting

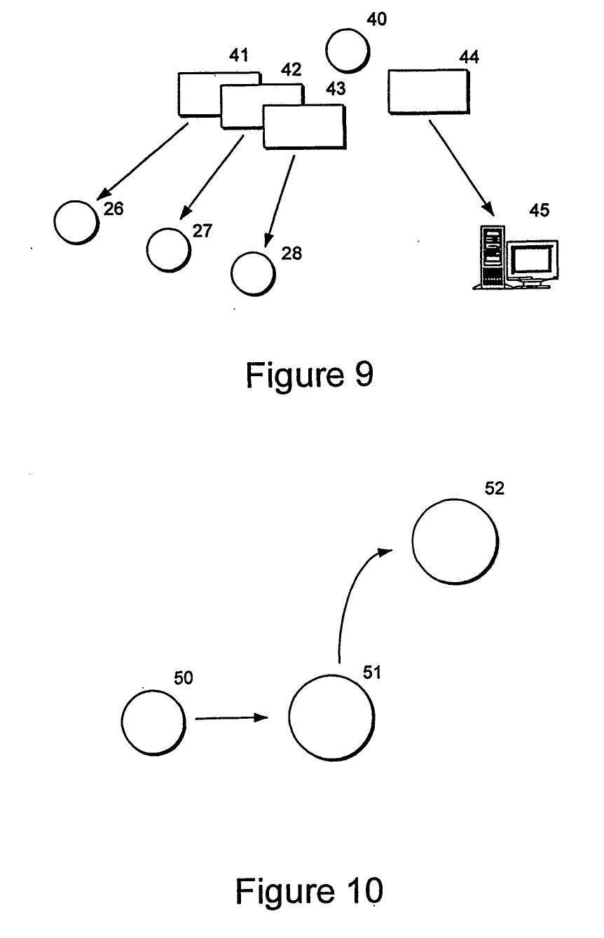

FIG. 9 shows the program running at a location 40. Referring to FIGS. 7 and 9, on receiving consent to e-mail a copy of itself, or a link to itself, to other recipients, the program creates an e-mail 41, 42, 43 for each recipient 26, 27, 28 (step s8) or a single e-mail to the remote computer 29 (step s17). At the same time the program creates a further e-mail message 44 (step s40) and sends it, for example over the Internet, to an accounting mail server 45, the body of the e-mail containing accounting statistics. The accounting statistics may contain, for example, the number of recipients to whom the program has been sent, in this example, three. As with the examples described above, the accounting e-mail 44 can alternatively be sent at predetermined times, after the software has been used a certain number of times or at times when an Internet connection is available. It will be understood that the accounting e-mail 44 is representative of a large number of accounting e-mails sent from different program locations to the mail server 45.

In the case of the second embodiment, since all advertising software traffic passes through the remote computer, the remote computer can be used to track the number of copies sent out

Web Hits Accounting

FIG. 10 shows the program running at a location 50, representative of a plurality of programs running at different locations. Referring to FIGS. 7 and 10, the software presents the user with a link to a web page containing the advertisement. When the user clicks on the link, the program starts up a web browser 51 which contacts a web server process 52 to retrieve the web page containing the advertisement and display it in the browser window (step s5/s13). At the same time, the access to the website is recorded as a hit (step s50). The web server 52 can therefore keep track of all the hits generated on the target web page, which reflects the number of times the program is run. Alternatively, this accounting data can be e-mailed to a specific e-mail address for accounting purposes.

In all of the above methods, the software can also send out the accounting data through the Internet, not necessarily in the form of e-mail messages, for example by sending datagrams using TCP, UDP or other TCP/IP protocols to specific ports on a remote accounting computer.

The consent of the software user can be sought before sending accounting statistics.

While the invention has been primarily described by reference to the sending of e-mails over the Internet, it is equally applicable to any type of electronic mailing system which permits any form of executable program to be transmitted between participants in the system. The program need not be immediately executable, but could for instance be included in a ZIP or other compressed file format.

1. A method of distributing digital content via an electronic mail system, the content being associated with an executable program received by a first recipient, the method comprising the steps of:
requesting consent from the first recipient to make the program available to a second recipient; and
in the event that consent is given, making the program available to the second recipient.

2. A method according to claim 1, wherein the step of making the program available comprises sending a copy of the program from the first recipient to the second recipient via the electronic mail system.

3. A method according to claim 1, wherein the step of making the program available comprises sending a link to a location from which the program is available from the first recipient to the second recipient via the electronic mail system.

4. A method according to claim 3, wherein the link comprises a website address.

5. A method according to claim 1, including sending information identifying the program from the first recipient to a remote computer, from where it is made available to the second recipient.

6. A method according to claim 5, wherein the step of making the program available comprises sending a copy of the program from the remote computer to the second recipient via the electronic mail system.

7. A method according to claim 5, wherein the step of making the program available comprises sending a link to a location from which the program is available from the remote computer to the second recipient via the electronic mail system.

8. A method according to claim 6 or 7, including the step of sending information identifying the first recipient from the remote computer to the second recipient.

9. A method according to any one of the preceding claims, wherein the step of requesting consent is performed by the program during its execution.

10. A method according to any one of the preceding claims, comprising amending the functionality of the program in dependence on the outcome of the request for consent.

11. A method according to claim 10, comprising reducing the functionality of the program in the event that consent to making the program available is refused.

12. A method according to any one of the preceding claims, wherein the digital content is embedded in the executable program.

13. A method according to any one of claims 1 to 12, wherein the program includes a link to the digital content.

14. A method according to claim 13, wherein the link comprises a website address.

15. A method according to any one of the preceding claims, including displaying the digital content to the user on execution of the program.

16. A method according to any one of the preceding claims, including identifying the second recipient from contact details held by the first recipient.

17. A method according to claim 16, comprising retrieving the contact details by scanning an address book stored by the first recipient.

18. A method according to claim 16, comprising retrieving the contact details by scanning for valid e-mail addresses.

19. A method according to any one of claims 1 to 15, including requesting the first recipient to provide contact details for the second recipient to identify the second recipient.

20. A method according to any one of the preceding claims, wherein the second recipient comprises a plurality of recipients.

21. A method according to any one of the preceding claims, further comprising rewarding the first recipient for providing contact addresses for the second recipient.

22. A method according to claim 21, comprising rewarding the first recipient in dependence on the validity of the provided contact addresses.

23. A method according to any one of the preceding claims, further comprising measuring the distribution of the digital content.

24. A method according to claim 23, comprising notifying a third recipient on execution of the program.

25. A method according to claim 23 or 24, further comprising notifying a third recipient that a message relating to the availability of the program has been sent to the second recipient.

26. A method according to any one of claims 23 to 25, further comprising recording access to a web page initiated from the program.

27. A method according to any one of the preceding claims, wherein the digital content comprises advertising content.

28. A method of advertisement distribution via an electronic mail system, comprising delivering an executable program to a first recipient, the program including data relating to the advertisement, requesting consent from the first recipient to make the program available to a second recipient, and in the event that consent is given, making the program available to the second recipient by electronic mail.

29. A method according to claim 28, wherein the data relating to the advertisement comprises the advertisement.

30. A computer program associated with digital content to be distributed via an electronic mail system, comprising means for requesting consent from a current user of the program to make the program available to at least one further user via an electronic mail system, and in the event consent is given, making the program available to said at least one further user.

31. A computer program according to claim 30 on a carrier medium.

32. A system for distributing digital content via an electronic mail system, the content being associated with an executable program received by a first recipient at a client computer, the program being configured to request consent from the first recipient to make the program available to a second recipient and in the event that consent is received, to send contact information for the second recipient and information identifying the program to a remote server, the remote server being configured to make the program available to the second recipient.

33. A system according to claim 32, wherein the server is configured to obtain the latest version of the program in response to the information identifying the program.
